(19) United States
(12) Patent Application Publication
(10) Pub. No.: US 2014/0114868 A1
(43) Pub. Date: Apr. 24, 2014

(54) METHODS AND SYSTEMS FOR EFFICIENT RECYCLING PICK UP SERVICES

(71) Applicant: EMPIRE TECHNOLOGY DEVELOPMENT LLC, Willmington, DE (US)

(72) Inventors: Feng Wan, Issaquah, WA (US); Timothy Martin Londergan, Seattle, WA (US); Shunichiro Kuroki, Tokyo (JP)

(21) Appl. No.: 13/878,665

(22) PCT Filed: Oct. 19, 2012
(86) PCT No.: PCT/US2012/060929

§ 371 Date: Apr. 10, 2013

(51) Int. Cl. G06Q 10/00

(52) U.S. Cl. CPC G06Q 10/30
USPC 705/308

(57) ABSTRACT

Methods and systems for collecting recyclables for recycling are disclosed. A collector may receive a collection request for recyclables for a consumer having an associated recycling account. The recycling account may include an address for the consumer. A determination as to whether an agent for the collector is within a threshold distance of the address may be made. The collector may fulfill the collection request in response to the agent for the collector being within the threshold distance of the address.

### BACKGROUND

Recycling is a process for processing used materials or waste into new products in order to prevent the waste of potentially useful materials, to reduce energy usage from the production of new materials, to reduce air pollution caused by the incineration of waste materials, or to reduce water pollution as a result of landfilling. Recycling can reduce the need for conventional waste disposal and lower greenhouse gas emissions as compared with virgin production of new materials.

Current recycling efforts have gradually gained traction at city, state and federal levels. However, recycling rates on different materials vary greatly because of the varied amount of extra effort required of consumers on materials to be recycled. For example, consumers cannot place electronic waste such as batteries, cell phones, tablets, and/or laptop computers into their recycle bins. Rather, special recycling centers are typically used for collecting electronic waste. As such, consumers must make a special trip to such a center in order to dispose of the electronic waste. In some cases, consumers are required to pay a disposal fee as part of this process as well. As a result, consumers are more likely to simply dispose of electronic waste in garbage bins than make an effort to recycle.

### SUMMARY

In an embodiment, a method of collecting recyclables for recycling may include receiving, by a collector, a collection request for recyclables for a consumer having an associated recycling account that includes an address for the consumer, determining whether an agent for the collector is within a threshold distance of the address, and fulfilling, by the collector, the collection request in response to the agent for the collector being within the threshold distance of the address.

In an embodiment, a method of collecting recyclables for recycling may include receiving, by a collector, a plurality of collection requests for recyclables for one or more consumers, where each consumer has an associated recycling account that includes an address for the consumer, and, for each collection request, fulfilling, by the collector, the collection request in response to the number of collection requests proximate to the address for the consumer meeting or exceeding a threshold value.

In an embodiment, a method of collecting recyclables for recycling may include receiving, by a computing device, a collection request for recyclables for a consumer having an associated recycling account, where the collection request comprises a request to collect one or more recyclables and the account comprises an address for the consumer and a recycling credit, transmitting, by the computing device, the collection request to a collector, determining, by the computing device, a collection recycling credit based on one or more of an amount of recyclables collected and a type of recyclable collected as a result of the collection request, and providing, by the computing device, the collection recycling credit to the recycling account associated with the consumer in response to the collection request being fulfilled.

In an embodiment, a system for collecting recyclables for recycling may include a computing device and a non-transitory processor-readable storage medium in operable communication with the computing device. The processor-readable storage medium may contain one or more programming instructions that, when executed, cause the computing device to receive a collection request for recyclables for a consumer having an associated recycling account that includes an address for the consumer, determine whether an agent for the collector is within a threshold distance of the address, and transmit the collection request to the agent in response to the agent being within the threshold distance of the address.

In an embodiment, a system for collecting recyclables for recycling may include a computing device and a non-transitory processor-readable storage medium in operable communication with the computing device. The processor-readable storage medium may contain one or more programming instructions that, when executed, cause the computing device to receive a plurality of collection requests for recyclables for one or more consumers, where each consumer has an associated recycling account that includes an address for the consumer, determine a location for each of the plurality of collection requests, and in response to one or more of the plurality of collection requests being within a threshold distance of each other, transmit the one or more collection requests to a collector.

In an embodiment, a system for collecting recyclables for recycling may include a computing device and a non-transitory processor-readable storage medium in operable communication with the computing device. The processor-readable storage medium contains one or more programming instructions that, when executed, cause the computing device to receive a collection request for recyclables for a consumer having an associated recycling account, where the collection request comprises a request to collect one or more recyclables and the account comprises an address for the consumer and a recycling credit, transmit the collection request to a collector, determine a collection recycling credit based on one or more of an amount of recyclables collected and a type of recyclables to be collected as a result of the collection request, and provide the collection recycling credit to the recycling account associated with the consumer.

### BRIEF DESCRIPTION OF THE FIGURES

FIG. 1 depicts a flow diagram for an illustrative method of collecting recyclables for recycling according to an embodiment.

FIG. 2 depicts a flow diagram for an alternate illustrative method of collecting recyclables for recycling according to an embodiment.

FIG. 3 depicts a flow diagram for yet another alternate illustrative method of collecting recyclables for recycling according to an embodiment.

FIG. 4 depicts a block diagram for an illustrative system for collecting recyclables for recycling according to an embodiment.

FIG. 5 depicts a block diagram of illustrative internal hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “agent” refers to an entity or individual that acts on behalf of another party. For example, an agent for a collector may include an entity or individual that acts on behalf of the collector to collect or receive recyclables. An agent for a collector may be a collaborator, a contractor, or an employee of the collector.

A “collection recycling credit” refers to a credit provided to a consumer for recycling a material. A collection recycling credit may correspond to a cash refund or reward, a tax credit, a coupon, a rebate, a credit, a discount or any other incentive provided to an entity or individual for recycling a recyclable.

A “collector” refers to an entity or individual that receives a recyclable for recycling. A collector may include a delivery company, a logistics company or a recyclables collector.

A “recyclable” refers to a material, a product, a container, or other item that is capable of being recycled. Recyclables may include, without limitation, electronic waste, such as batteries, electronic components, computers, portable electronic devices, cell phones, tablets, monitors, peripherals, printers, optical disks, furniture, clothes, bottles, can, container, home appliances such as dish washer, heater, kitchen ranges, refrigerators, washer, dryer, oven, and air conditioner, food (before or after expiration date), books, optical disks such as CDs, DVDs, and Blu-rays, and/or the like. Recyclables may further include, without limitation, plastics, polymers such as polyethylene terephthalate (PET), polyethylene, polyvinyl chloride (PVC), polypropylene, polystyrene, polytetrafluoroethylene (PTFE), polyurethane, polyimide, polyacrylamide, starch-based polymers, protein based polymers, polysaccharides, polylactic acid (PLA), polymer composites, cellulosic materials, lignocellulosic materials, fabrics, metals, such as aluminum, brass, copper, iron, steel, zinc, silver, rare earth metals, and/or the like, alloys, cardboard, glass, paper, plywood, wood, motor oil, tires, and vehicular batteries. Additional recyclable materials may also be considered within the scope of this disclosure and may be recycled according to the teachings described herein.

A “recycling account” refers to an account associated with an individual or entity account holder that is used to record recycling activities associated with the account holder. The recycling account may include an address associated with the account holder and a recycling credit based on the account holder's recycling activities.

This disclosure identifies methods and systems for determining a recycling credit for a recycled material. In particular, this disclosure identifies methods and systems for determining a recycling credit for a recycled material produced by a materials producer or manufacturer.

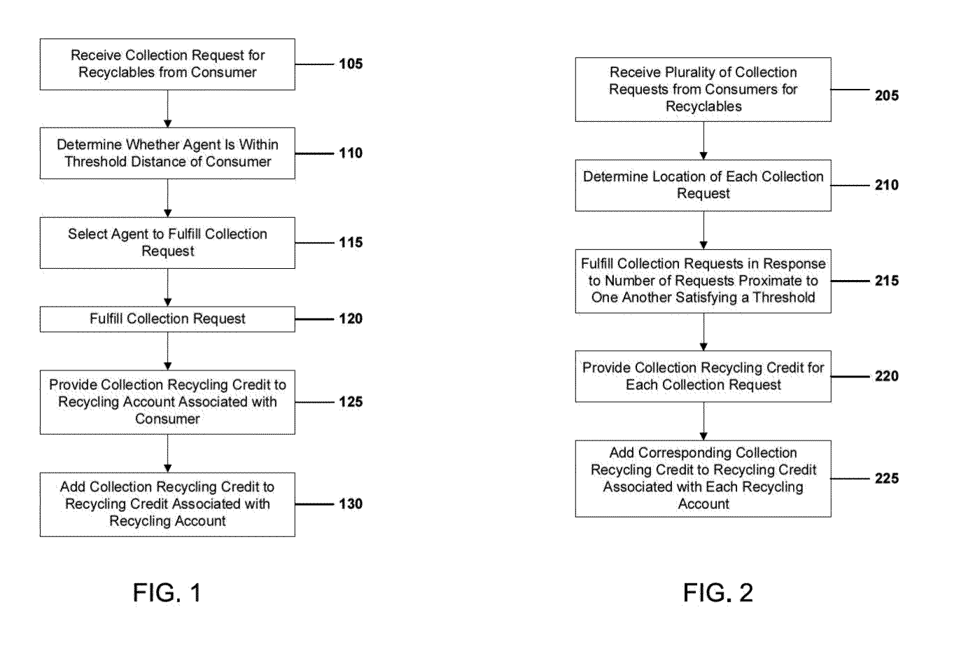

FIG. 1 depicts a flow diagram for an illustrative method of collecting recyclables for recycling according to an embodiment. As shown in FIG. 1, a collector may receive 105 a collection request for recyclables for a consumer having an associated recycling account. The recycling account may include an address for the consumer. In an embodiment, the recycling account may be an account associated with electronic waste recycling activities by the consumer. For example, the recycling account may record information regarding electronic waste that has been recycled by the consumer, such as an amount of recycled electronic waste, types of recycled electronic waste, a chemical or material composition of recycled electronic waste, a monetary value associated with recycled electronic waste and/or the like.

In an embodiment, the collection request may be received 105 by a computing device associated with the collector. In an embodiment, the collection request may include a request to collect electronic waste. In an embodiment, the collector may include a recyclables collector. In an embodiment, the collector may include a delivery company or a logistics company.

A determination may be made 110 as to whether an agent for the collector is within a threshold distance of the address of the consumer. In an embodiment, a computing device may determine 110 the distance between the address of the consumer and one or more agents for a collector. In an embodiment, an agent of the collector may include a representative of a delivery company, a representative of a logistics company, a delivery company or a logistics company.

In an embodiment, an agent for the collector may be selected 115 to fulfill the collection request. In an embodiment, an agent for the collector having a shortest distance between the agent's location and the consumer's address may be selected 115. Other methods of selecting 115 an agent may be performed within the scope of this disclosure.

The collector may fulfill 120 the collection request in response to the agent for the collector being within a threshold distance of the address. Fulfillment 120 of the request may be performed by having the collector or an agent for the collector retrieve recyclables from the consumer in response to the collection request.

In an embodiment, the recycling account may include a recycling credit associated with the consumer. In such an embodiment, a collection recycling credit may be provided 125 to the recycling account for the consumer. The collection recycling credit may be based on one or more of an amount of recyclables collected and a type of recyclables collected as a result of the collection request. The collection recycling credit may be added 130 to the recycling credit associated with the recycling account for the consumer. In an embodiment, the collection recycling credit may include one or more of a coupon, cash, a tax credit and a rebate. In an embodiment, the collection recycling credit may include a credit applied to one or more of a credit card, a debit card and a value card of the consumer. In an embodiment, the collection recycling credit may include a discount applied to a purchase from a merchant.

FIG. 2 depicts a flow diagram for an alternate illustrative method of collecting recyclables for recycling according to an embodiment. As shown in FIG. 2, a collector may receive 205 a plurality of collection requests for recyclables for one or more consumers. Each consumer may have an associated recycling account. Each recycling account may include an address for the associated consumer. In an embodiment, each consumer's recycling account may be accessible by the collector. In an embodiment, each recycling account may be an account associated with electronic waste recycling activities by the consumer. For example, the recycling account may record information regarding electronic waste that has been recycled by the consumer, such as an amount of recycled electronic waste, types of recycled electronic waste, a chemical or material composition of recycled electronic waste, a monetary value associated with recycled electronic waste and/or the like. In an embodiment, each recycling account may further include a recycling credit associated with the associated consumer. For example, the recycling credit may denote an amount of credit that the consumer has accumulated for past recycling activities and has not redeemed to date or within a prescribed time period.

In an embodiment, each of the plurality of collection requests may be received 205 by a computing device associated with the collector. In an embodiment, the collection requests may each include a request to collect electronic waste. In an embodiment, the collector may be a recyclables collector. In an embodiment, the collector may be a delivery company or a logistics company. In an embodiment, the collector may be a retailer. In an embodiment, the collector may be a manufacturer.

The collector may determine 210 a location for each of the collection requests. In an embodiment, the location may be determined 210 based on the address associated with the consumer making each collection request. In an embodiment, one or more of the collection requests may include a location at which the collection is to take place.

For each collection request, the collector may fulfill 215 the collection request in response to the number of collection requests proximate to the address for the consumer meeting or exceeding a threshold value. For example, a minimum of five collection requests are required before the collector fulfills 215 the collection request. In an embodiment, the collector may fulfill 215 the collection requests only if the collection requests are within a particular radius of each other, such as within five kilometers. In an embodiment, the collector may fulfill 215 the collection requests only if the collection requests can be completed within an identified amount of time. In an alternate embodiment, the collector may fulfill 215 the collection requests only if the average time to complete the collection requests is less than a threshold value, such as, without limitation, 10 minutes per collection request. In an embodiment, the collector may fulfill 215 the collection requests only if the collection requests can be completed by travelling less than an identified distance. In an alternate embodiment, the collector may fulfill 215 the collection requests only if the distance to travel per collection request is less than an identified distance. Alternate parameters for determining when to fulfill collection requests may also be performed within the scope of this disclosure.

In an embodiment, a collection recycling credit may be provided 220 for each collection request. The collection recycling credit may be provided 220 to the recycling account associated with the consumer that made the collection request. The collection recycling credit may be based on one or more of an amount of recyclables collected and a type of recyclables collected as a result of the collection request. The collection recycling credit may be added 225 to the recycling credit associated with the recycling account for the consumer. In an embodiment, the collection recycling credit may include one or more of a coupon, cash, a tax credit and a rebate. In an embodiment, the collection recycling credit may include a credit applied to one or more of a credit card, a debit card and a value card of the consumer that made the collection request. In an embodiment, the collection recycling credit may include a discount applied to a purchase from a merchant.

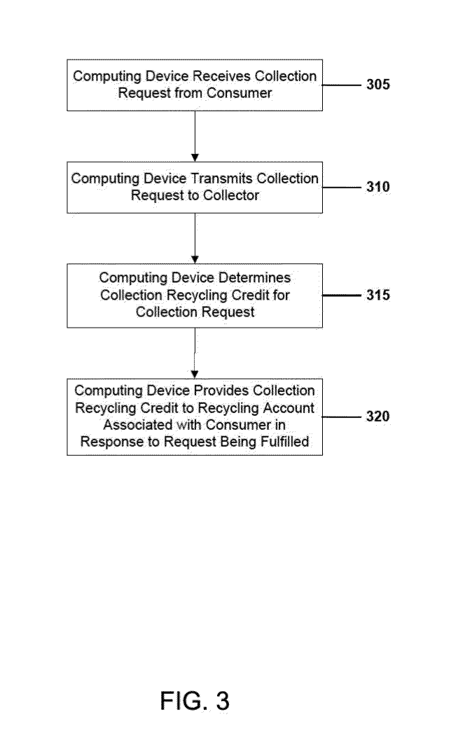

FIG. 3 depicts a flow diagram for yet another alternate illustrative method of collecting recyclables for recycling according to an embodiment. As shown in FIG. 3, a computing device may receive 305 a collection request for recyclables for a consumer having an associated recycling account. The collection request may include a request to collect one or more recyclables. The recycling account may include an address for the consumer and a recycling credit. In an embodiment, the recycling account may include an electronic waste account. In an embodiment, the recycling account may be an account associated with electronic waste recycling activities by the consumer. For example, the recycling account may record information regarding electronic waste that has been recycled by the consumer, such as an amount of recycled electronic waste, types of recycled electronic waste, a chemical or material composition of recycled electronic waste, a monetary value associated with recycled electronic waste and/or the like. In an embodiment, the collection request may include a request to collect electronic waste.

The computing device may transmit 310 the collection request to a collector. In an embodiment, the collector may include a recyclables collector. In an embodiment, the collector may include a delivery company or a logistics company.

The computing device may determine 315 a collection recycling credit. In an embodiment, the collection recycling credit may be determined 315 based on one or more of an amount of recyclables collected and a type of recyclables collected as a result of the collection request.

The computing device may provide 320 a collection recycling credit to the recycling account associated with the consumer in response to the collection request being fulfilled. For example, the computing device may receive a fulfillment notification from the collector after the collection request has been fulfilled. In an alternate embodiment, fulfillment of the collection request may be identified based on a tracking system associated with the collector. For example, when the collector is co-located with the address associated with the consumer, the computing device may identify fulfillment of the collection request. Other methods of determining whether a collection request has been fulfilled may be performed within the scope of this disclosure.

In an embodiment, the collection recycling credit may include one or more of a coupon, cash, an account credit, a tax credit and a rebate. In an embodiment, the collection recycling credit may include a credit applied to one or more of a credit card, a debit card and a value card of the consumer. In an embodiment, the collection recycling credit may include a discount applied to a purchase from a merchant.

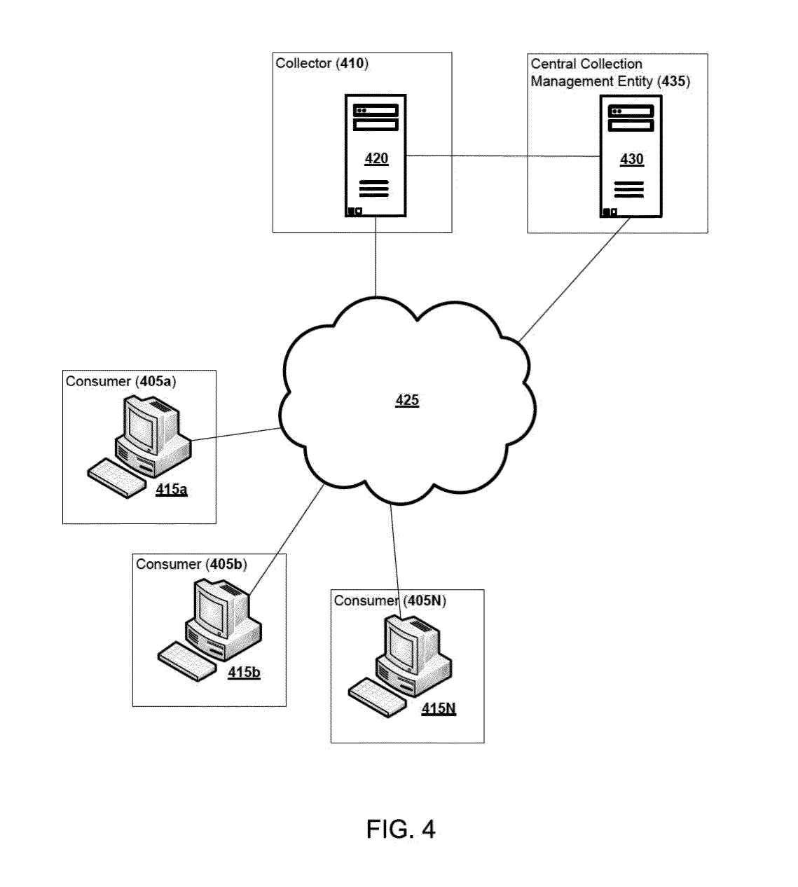

FIG. 4 depicts a block diagram for an illustrative system for collecting recyclables for recycling according to an embodiment. As shown in FIG. 4, a plurality of consumers, such as 405a-N, may be resident within a geographical location. One or more collectors, such as 410, may service the geographical location with respect to collecting recyclables from the consumers. Each of the consumers may have a communication device, such as 415a-N. The communication devices 415a-N may be used to communicate collection requests. In an embodiment, the collection requests may be transmitted directly to a communication device, such as 420, associated with the collector 410 via a communication network, such as 425. Upon receiving the collection request, and possibly other collection requests, the collector may collect the recyclables from the one or more consumers 405a-N that made a collection request.

In an alternate embodiment, the collection request may be transmitted to a communication device 430 associated with a central collection management entity 435 operated by, for example and without limitation, a recycling facility, a governmental agency, or the like. The central collection management entity 435 may select a collector 410 from one or more collectors to fulfill the one or more collection requests. Selection of the collector 410 to perform the collection request may be performed based upon, for example, proximity of the collector to one or more consumers, such as 405a-N, from which collection requests have been received. Additional and/or alternate systems for collecting recyclables may be used within the scope of this disclosure.

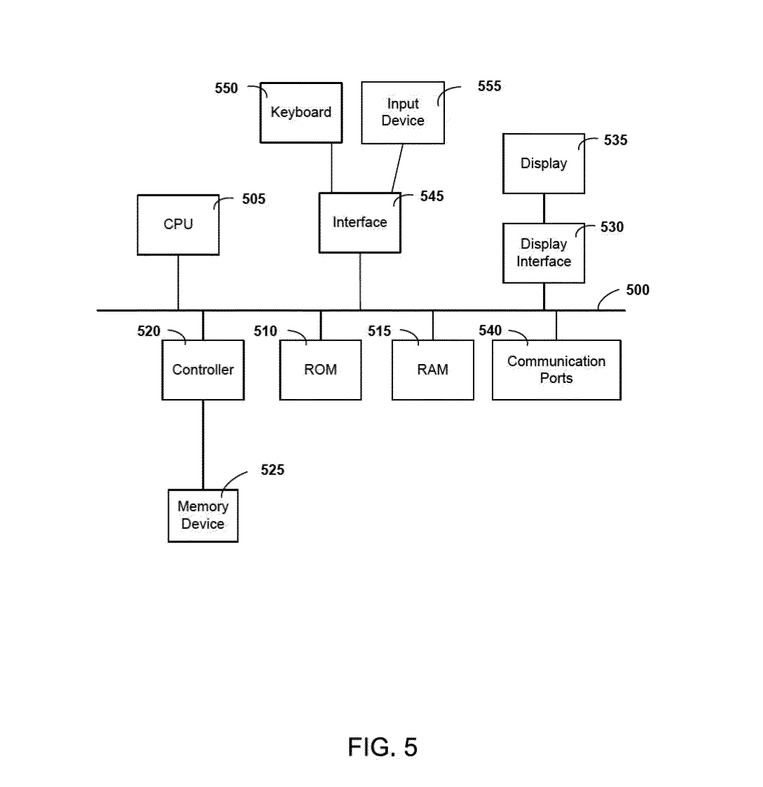

FIG. 5 depicts a block diagram of exemplary internal hardware that may be used to contain or implement program instructions, such as the process steps discussed above in reference to FIGS. 1-3, arranged in accordance with at least some embodiments described herein. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 510 and random access memory (RAM) 515 constitute exemplary memory devices (i.e., non-transitory processor-readable storage media).

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 500 to be displayed on the display 535 in audio, visual, graphic or alphanumeric format. Communication with external devices, such as a print device, may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

### EXAMPLES

### Example 1

### Collection Request via Central Authority

Collection requests will be received by a computing device located at a central authority. Collection requests will be entered either automatically if submitted by a computing device or manually if received by telephonic or written correspondence. Upon receiving a collection request, the computing device at the central authority will determine a collector that is equipped to handle the collection request. As part of this process, the computing device will determine the proximity of the collector to the location at which the recyclables are to be collected, although other factors will also be considered (type of recyclable to be collected, other collection requests currently being handled by a collector, etc.). The computing device will then send the collection request to the collector for processing. The collector will perform the collection and provide feedback to the central authority regarding the fulfillment of the collection request. As part of the feedback, the collector will provide information regarding the amount and types of recyclables collected as a result of the collection request. The computing device at the central authority will use this feedback information to determine a collection recycling credit to be added to an account associated with the consumer making the collection request. The collection recycling credit will be summed with any prior stored recycling credit to provide an updated recycling credit for the consumer.

### Example 2

### Collection Requests via Collector

A collector will receive a plurality of collection requests from one or more consumers. The collection requests will be received directly from the one or more consumers and/or from a central authority. Each collection request will include an address or location associated with a requested collection. The collector will determine whether a sufficient number of collection requests occur to warrant sending an agent to fulfill the collection requests. This will be done by determining an amount of time required to fulfill the collection requests and/or proximity of the collection requests to each other. For example, if five collection requests are made within a one kilometer radius of each other, the collector will send an agent to fulfill the collection requests. If a sufficient number of collection requests are within a geographic location to warrant sending an agent, the agent will be sent to fulfill the collection requests. As the collection requests are fulfilled (or after all of the collection requests are fulfilled), the collector will update information pertaining to a recycling credit in each account associated with a fulfilled collection request. Particularly, the collector will determine a collection recycling credit to be added to an account associated with a consumer making the collection request. The collection recycling credit will be summed with any prior stored recycling credit to provide an updated recycling credit for the consumer.

### Example 3

### Use of Recycling Account by Consumer

A consumer will be assigned or will sign up for a recycling account with a central authority or a collector. As part of the account formation process, the consumer will provide an address at which collections are to take place. In addition, the recycling account will store a recycling credit. The consumer will then submit a collection request to the entity with which the recycling account was formed. A collector will be sent to collect recyclables associated with the collection request from the consumer. The recycling credit stored in the recycling account will be updated based on the amount and type of recyclables received by the collector as part of the collection request. For example, if the recycling account for a consumer had a $10 recycling credit before the collection request, and recyclables worth a $15 credit were received in fulfillment of the collection request, the recycling account would be updated to reflect a $25 recycling credit. The consumer will then use the recycling credit to purchase goods or services from one or more participating vendors.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of collecting recyclables for recycling, the method comprising:
receiving, by a collector, a collection request for recyclables for a consumer having an associated recycling account, wherein the recycling account comprises an address for the consumer;
determining whether an agent for the collector is within a threshold distance of the address; and
fulfilling, by the collector, the collection request in response to the agent for the collector being within the threshold distance of the address.

2. The method of claim 1, further comprising selecting the agent for the collector to fulfill the collection request.

3. The method of claim 2, wherein selecting the agent comprises selecting the agent having a shortest distance between the agent's location and the address.

4. The method of claim 1, wherein the recycling account comprises an electronic waste account.

5. The method of claim 1, wherein the collection request comprises a request to collect electronic waste.

6. The method of claim 1, wherein the recycling account further comprises a recycling credit associated with the consumer.

7. The method of claim 6, further comprising:
providing a collection recycling credit to the recycling account for the consumer, wherein the collection recycling credit is based on one or more of an amount of recyclables collected and a type of recyclable collected as a result of the collection request; and
adding the collection recycling credit to the recycling credit associated with the recycling account for the consumer.

8-11. (canceled)

12. The method of claim 1, wherein the collector comprises a delivery company or a logistics company.

13-23. (canceled)

24. A method of collecting recyclables for recycling, the method comprising:
receiving, by a computing device, a collection request for recyclables for a consumer having an associated recycling account, wherein the collection request comprises a request to collect one or more recyclables, wherein the recycling account comprises an address for the consumer and a recycling credit;
transmitting, by the computing device, the collection request to a collector;
determining, by the computing device, a collection recycling credit based on one or more of an amount of recyclables collected and a type of recyclable collected as a result of the collection request; and
providing, by the computing device, the collection recycling credit to the recycling account associated with the consumer in response to the collection request being fulfilled.

25. The method of claim 24, wherein the recycling account comprises an electronic waste account.

26. The method of claim 24, wherein the collection request comprises a request to collect electronic waste.

27-29. (canceled)

30. The method of claim 24, wherein the collector comprises a recyclables collector.

31. The method of claim 24, wherein the collector comprises a delivery company or a logistics company.

32. A system for collecting recyclables for recycling, the system comprising:
a computing device; and
a non-transitory processor-readable storage medium in operable communication with the computing device, wherein the processor-readable storage medium contains one or more programming instructions that, when executed, cause the computing device to:
receive a collection request for recyclables for a consumer having an associated recycling account, wherein the recycling account comprises an address for the consumer,
determine whether an agent for the collector is within a threshold distance of the address, and
transmit the collection request to the agent in response to the agent being within the threshold distance of the address.

33. The system of claim 32, wherein the processor-readable storage medium further comprises one or more programming instructions that, when executed, cause the computing device to select the agent for the collector to fulfill the collection request.

34. The system of claim 33, wherein the one or more programming instructions that, when executed, cause the computing device to select the agent comprise one or more programming instructions that, when executed, cause the computing device to select the agent having a shortest distance between the agent's location and the address.

35. The system of claim 32, wherein the recycling account comprises an electronic waste account.

36. The system of claim 32, wherein the collection request comprises a request to collect electronic waste.

37. The system of claim 32, wherein the recycling account further comprises a recycling credit associated with the consumer.

38. The system of claim 32, wherein the processor-readable storage medium further comprises one or more programming instructions that, when executed, cause the computing device to:
provide a collection recycling credit to the recycling account for the consumer, wherein the collection recycling credit is based on one or more of an amount of recyclables collected and a type of recyclable collected as a result of the collection request.

39. The system of claim 38, wherein the one or more programming instructions that, when executed, cause the computing device to provide a collection recycling credit to the recycling account for the consumer comprise one or more programming instructions that, when executed, cause the computing device to add the collection recycling credit to the recycling credit associated with the recycling account.

40-42. (canceled)

43. The system of claim 32, wherein the collector comprises a recyclables collector.

44. The system of claim 32, wherein the collector comprises a delivery company or a logistics company.

45-56. (canceled)

57. A system for collecting recyclables for recycling, the system comprising:
a computing device; and
a non-transitory processor-readable storage medium in operable communication with the computing device, wherein the processor-readable storage medium contains one or more programming instructions that, when executed, cause the computing device to:
receive a collection request for recyclables for a consumer having an associated recycling account, wherein the collection request comprises a request to collect one or more recyclables, wherein the recycling account comprises an address for the consumer and a recycling credit,
transmit the collection request to a collector,
determine a collection recycling credit based on one or more of an amount of recyclables collected and a type of recyclables to be collected as a result of the collection request, and
provide the collection recycling credit to the recycling account associated with the consumer.

58. The system of claim 57, wherein the recycling account comprises an electronic waste account.

59. The system of claim 57, wherein the collection request comprises a request to collect electronic waste.

60-62. (canceled)

63. The system of claim 57, wherein the collector comprises a recyclables collector.

64. The system of claim 57, wherein the collector comprises a delivery company or a logistics company.
